(19) United States
(12) Patent Application Publication
(10) Pub. No.: US 2019/0266278 A1
(43) Pub. Date: Aug. 29, 2019

(54) IoT Data Management System and Method

(71) Applicant: Altibase Corp., Seoul (KR)

(72) Inventors: Joon Ho Park, Seoul (KR); Kwang Ik Seo, Incheon (KR); Jong Jeong Lee, Gyeonggi-do (KR)

(21) Appl. No.: 15/926,492

(22) Filed: Mar. 20, 2018

(30) Foreign Application Priority Data
Feb. 26, 2018 (KR) 10-2018-0022974

(51) Int. Cl. G06F 17/30; H04L 29/08

(52) U.S. Cl. CPC G06F 17/30584; H04L 67/10; H04L 67/12; G06F 17/30507

(57) ABSTRACT

Provided is an Internet of Things (IoT) data management system, the architecture of which is configured in three-level layers of an edge layer, a fog layer, and a cloud layer.

### CROSS-REFERENCE TO RELATED APPLICATION

This application claims the benefit of Korean Patent Application No. 10-2018-0022974, filed on Feb. 26, 2018, in the Korean Intellectual Property Office, the disclosure of which is incorporated herein in its entirety by reference.

### BACKGROUND

### 1. Field

One or more embodiments relate to an Internet of Things (IoT) data management system and a method of configuring the architecture of the IoT data management system in three-level layers.

### 2. Description of the Related Art

With the recent development of Internet of Things (IoT) technology and devices, there is an increasing demand for maximizing production efficiency and management by using a large amount of real-time data continuously generated in industrial sites. To this end, data platform technology for IoT data generated in sites and various types of large capacity analysis is required. However, the development of database management and data interworking technology suitable for an IoT environment is mostly focused on time-series data management technology, and technology capable of processing or transmitting data in real time at the same time as generation of IoT data is not supported.

### CITATION LIST

### Patent Literature

U.S. Ser. No. 14/085,621

### Non Patent Literature

1. Shusen Yang, “IoT Stream Processing and Analytics in The Fog.” arXiv preprint arXiv:1705.05988, 2017

2. Trupti Gurav, R. A. Kudale, “DoT: Requirements and Selection Criteria,” IJCA 2017

3. http://www.opto22.com/site/pr_selector.aspx?cid=1&qs=1005#1021

4. https://developer.cisco.com/site/iox/docs

5. https://developercouchbase.com/documentation/mobmob/1.4/guides/sync-gateway/index.html

6. https://www.automationworld.com/fog-computing-vs-edge-computing-whats-difference

### SUMMARY

One or more embodiments include an Internet of Things (IoT) data management system capable of processing data in real time at a point at which IoT data is generated and storing and analyzing a large amount of data based on a distributed in-memory.

Additional aspects will be set forth in part in the description which follows and, in part, will be apparent from the description, or may be learned by practice of the presented embodiments.

According to one or more embodiments, an IoT data management system is configured in three-level layers of a terminal, a middleware, and a cloud database (DB), wherein the terminal implements an edge layer function of storing, analyzing, and managing IoT data in real time, the middleware implements a fog layer function of distributing and transmitting the IoT data between the terminal and the cloud DB, and the cloud DB implements a cloud layer function.

The terminal may include a processor and a storage, and the processor and the storage may collect, analyze, and store IoT data in real time.

The terminal may support communication through a gateway function and may further support a function of distributing and controlling the IoT data.

The cloud DB may be implemented with a distributed in-memory cloud embedded database management system (DBMS).

The cloud DB may include: at least one in-memory shard DB configured to store distributed IoT data; and a meta node configured to analyze a user query received from the terminal, determine whether the user query is a shard query including a shard object, and when the user query is the shard query, distribute and process IoT data to the at least one in-memory shard DB based on a shard key.

The terminal may include a shard library provided in a library form in the terminal and configured to perform a coordinator role between the terminal and the at least one in-memory shard DB, transmit the user query to the meta node, receive information about the at least one shard DB, and perform a connection between the terminal and the at least one in-memory shard DB.

According to one or more embodiments, a method of generating an architecture of an IoT data management system includes: generating three-level layers of a terminal, a middleware, and a cloud database (DB); performing, by the terminal including a processor and a storage, an edge layer function of storing, analyzing, and managing IoT data in real time; performing, by the middleware, a fog layer function of distributing and transmitting the IoT data between the terminal and the cloud DB; and performing, by the cloud DB, a cloud layer function.

The cloud DB may be implemented with a distributed in-memory cloud embedded database management system (DBMS).

The cloud DB may include: at least one in-memory shard DB configured to store distributed IoT data; and a meta node configured to analyze a user query received from the terminal, determine whether the user query is a shard query including a shard object, and when the user query is the shard query, distribute and process IoT data to the at least one in-memory shard DB based on a shard key.

The terminal may include a shard library provided in a library form in the terminal and configured to perform a coordinator role between the terminal and the at least one in-memory shard DB, transmit the user query to the meta node, receive information about the at least one shard DB, and perform a connection between the terminal and the at least one in-memory shard DB.

The terminal may use an embedded DB.

### BRIEF DESCRIPTION OF THE DRAWINGS

These and/or other aspects will become apparent and more readily appreciated from the following description of the embodiments, taken in conjunction with the accompanying drawings in which:

FIG. 1 is an internal configuration diagram of an Internet of Things (IoT) data management system, according to an embodiment;

FIGS. 2 and 3 illustrate an example of performing cloud sharding in a cloud database (DB), according to an embodiment; and

FIG. 4 is a flowchart of a method of configuring an architecture of an IoT data management system in three-level layers, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

Hereinafter, embodiments of the present disclosure will be described in detail with reference to the accompanying drawings. The advantages and features of the present disclosure and methods for achieving the same will become apparent from the following embodiments that are described in detail in conjunction with the accompanying drawings.

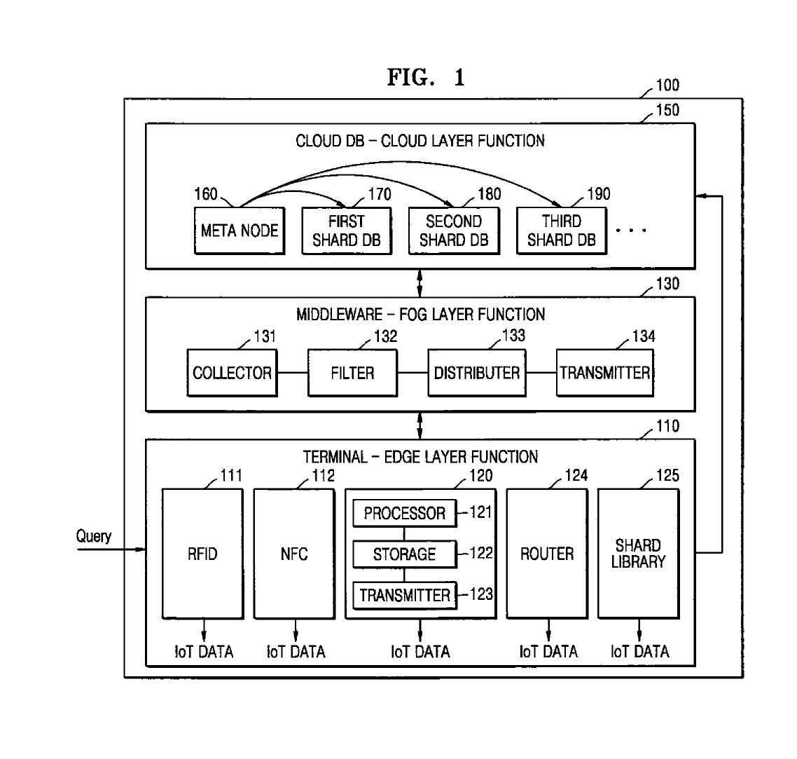

FIG. 1 is an internal configuration diagram of an IoT data management system, according to an embodiment.

Most of Interest of Things (IoT) application programs use a client-server architecture based on a front-end intelligent device and a back-end cloud. However, data response is delayed due to long distance communication between billions of terminals and a cloud data storage, and it is difficult to process big data stream capacity generated by billions of terminals in real time.

In order to solve the problem of the response speed and the throughput, an IoT data management system 100 according to an embodiment includes three-level layers of a terminal 110, a middleware 130, and a cloud DB 150.

The terminal 110 may implement an edge layer function of storing, analyzing, and managing IoT data in real time, may perform processing according to diversity of IoT data and a size and generation speed of heavily increased IoT data, may process IoT data in real time, and may perform integration and processing of IoT data.

The terminal 110 includes a notebook, a computer, a hand-held device, a robot, a wearable device, and an IoT device 120. The terminal 110 further includes a processor 121 configured to process acquired IoT data in real time, and a storage 122 configured to store IoT data, and a transmitter 123 configured to transmit IoT data.

The terminal 110 may also perform a routing function 124 such as a gateway as well as IoT data processing and may further have a control function capable of distributing data to the cloud DB 150 by using a shard library 125.

According to an embodiment, the terminal 110 may use Opto22 PAC or the like for collecting and digitizing various IoT data generated from various IoT devices. The storage 122 of the terminal 110 may store and manage IoT data collected from various data sources in real time by using an embedded database management system (DBMS). The IoT data includes various data, such as sensor data 111 and 112, XML-type data, HTML-type data, text data, audio data, and video data.

According to an embodiment, the middleware 130 performs a fog layer function of distributing, transmitting, and synchronizing IoT data between the terminal 110 and the cloud DB 150. In this case, the middleware 130 simply collects IoT data received from the terminal 110 through a collector 131, filters the collected IoT data through a filter 132, and distributes or transmits the filtered IoT data to the cloud DB 150 through a distributer 133 and a transmitter 134.

According to an embodiment, the middleware 130 distributes and transmits the IoT data by applying complex event processing (CEP). According to an embodiment, the middleware 130 applies CEP disclosed in US 2014-0149419 A1.

According to an embodiment, the edge layer function of the terminal 110 and the fog layer function of the middleware 130 may be performed in hardware such as Raspberry Pi.

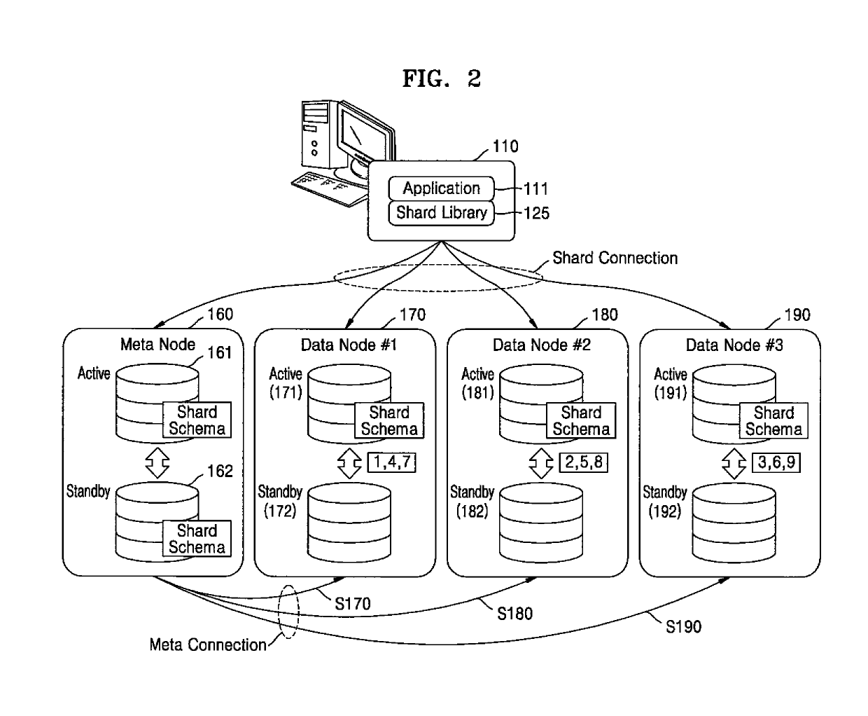

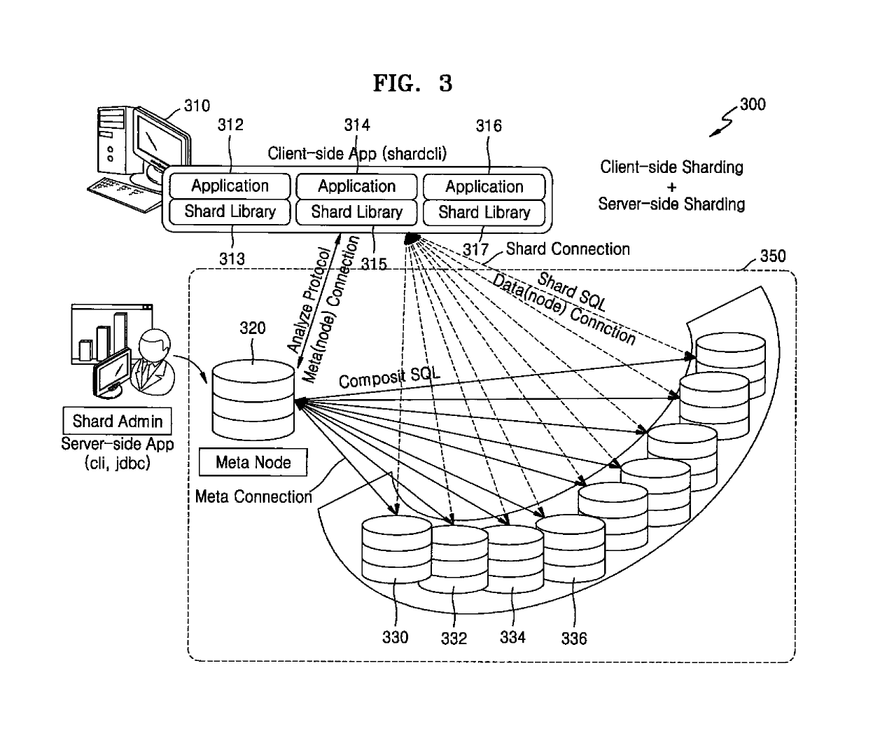

According to an embodiment, the cloud DB 150 implements a cloud layer function. According to an embodiment, the cloud layer function supports cloud sharding. An example of performing cloud sharding will be described with reference to FIGS. 2 and 3.

Sharding is a scale-out technology of distributing data stored in a single DB into several DBs and storing and processing the distributed data. According to an embodiment, since the cloud DB 150 performs sharding, the cloud DB 150 may process large-capacity data processing in an extension of installations of systems based on scale-out using an inexpensive system, without introducing high-performance systems.

Cloud sharding will be described with reference to FIG. 2. The terminal 110 includes an installable client application 111 and provides a shard library 125 in an application. According to an embodiment, could sharding, which is performed in the client DB 150, may use any application programs provided in the terminal 110 without editing the application programs.

The cloud DB 150 includes a meta node 160 and at least one in-memory shard DB configured to store distributed data, namely, in-memory shard DBs 170, 180, and 190. The meta node 160 and the at least one in-memory shard DB 170, 180, and 190 may be duplicated into active DBs 161, 171, 181, and 191 and standby DBs 162, 172, 182, and 192.

The shard library 125 provided in the terminal 110 performs a coordinator role between the application 111 provided in the terminal 110 and the at least one in-memory shard DBs 170, 180, and 190.

The meta node 160 of the cloud DB 150 manages the at least one in-memory shard DB 170, 180, and 190 and sharding information, analyzes a user query, and performs a coordinator role, such as provision of an integrated query during server-side sharding. The meta node 160 also performs a function of re-distributing IoT data to the at least one in-memory shard DB 170, 180, and 190 (S170, S180, and S190).

The function of the sharding performed in the cloud DB 150, according to an embodiment, will be described with reference to FIG. 3.

The cloud DB 150 generally performs server-side sharding, but if necessary, may implement client-side sharding. In addition, if necessary, the cloud DB 150 may be implemented to select only server-side sharding or client-side sharding.

According to an embodiment, at least one shard library 313, 315, and 317 is provided in the terminal 310 in a library form, performs sharding, and provides the same API interface as an existing open DB connectivity (ODBC).

The at least one shard library 313, 315, and 317 may perform a coordinator role between client applications 312, 314, and 316 and in-memory shard DBs 330, 332, 334, and 336.

According to an embodiment, the applications 312, 314, and 316 provided in the terminal 310 attempt to access a meta node 320 of the cloud DB 350 via the at least one shard library 313, 315, and 317. That is, the applications 312, 314, and 316 may perform meta connection. The applications 312, 314, and 316 may access the meta node 320 in the same method as a general DB accessing method.

In addition, the applications 312, 314, and 316 provided in the terminal 310 attempt to access the at least one in-memory shard DB 330, 332, 334, and 336 of the cloud DB 350 via the at least one shard library 313, 315, and 317. That is, the applications 312, 314, and 316 may perform shard connection.

According to an embodiment, the meta node 320 of the cloud DB 350 manages the at least one in-memory shard DB 330, 332, 334, and 336 and sharding information, analyzes a user query, and performs a coordinator role, such as provision of an integrated query during server-side sharding. The meta node 320 may also perform a function of re-distributing IoT data to the in-memory DBs 330, 332, 334, and 336.

According to an embodiment, shard connection management when the cloud DB 350 implements server-side sharding is performed as follows.

The meta node 320 creates a session, and the applications 312, 314, and 316 request the meta node 320 for a user query including a shard object.

An example of determining whether the user query is a shard query including a shard object is as follows.

```
    /* After a node is completely configured, a table is created in each node */
    CREATE TABLE t1(id INTEGER, name VARCHAR(50));
    /* T1 is set as a shard table */
    EXEC DBMS_SHARD.SET_SHARD_TABLE(‘SYS’, ‘T1’, ‘R’, ‘ID’, ‘NODE1’);
    EXEC DBMS_SHARD.SET_SHARD_RANGE(‘SYS’, ‘T1’, 3, ‘NODE2’);
    EXEC DBMS_SHARD.SET_SHARD_RANGE(‘SYS’, ‘T1’, 6, ‘NODE3’);
    /* Data is input to each node */
    INSERT INTO t1 VALUES(1, ‘Kim’);
    INSERT INTO t1 VALUES(2, ‘Lee’);
    INSERT INTO t1 VALUES(3, ‘Park’);
    INSERT INTO t1 VALUES(4, ‘Choi’);
    INSERT INTO t1 VALUES(5, ‘Jeong’);
    INSERT INTO t1 VALUES(6, ‘Kang’);
    INSERT INTO t1 VALUES(7, ‘Joe’);
    INSERT INTO t1 VALUES(8, ‘Yoon’);
    INSERT INTO t1 VALUES(9, ‘Jang’);
    /* Query test */
    iSQL> SELECT * FROM t1 WHERE id = 2;
    Because an inquiry is possible only in a specific node, a normal operation
is performed.
    ID NAME
    2 Lee
    1 row selected.
    iSQL> SELECT* FROM t1; -- Since T1 is a shard table, an error is generated
during a single query inquiry.
    [ERR-E1385 : The shard table is only available inside the shard view.:
    0001 : SELECT * FROM T1
    ]
    iSQL> SHARD SELECT * FROM t1; -- When all distributed and stored pieces
of data are checked, a “SHARD” sentence is used.
    ID NAME
    7 Joe
    8 Yoon
    9 Jang
    1 Kim
    2 Lee
    3 Park
    4 Choi
    5 Jeong
    6 Kang
    9 rows selected.
    iSQL> SELECT * FROM t1 WHERE id = 2 OR id = 3; -- Because an inquiry is
possible only in a specific node, a normal operation is performed.
    ID NAME
    2 Lee
    3 Park
    2 rows selected.
    iSQL> SELECT COUNT(*) FROM t1; -- Because a sum of all nodes needs to
be obtained and inquired, an error is generated when a single query is used.
    [ERR-E1385 : The shard table is only available inside the shard view.:
    0001 : SELECT COUNT(*) FROM T1
    ]
    iSQL> SHARD SELECT COUNT(*) FROM t1;
    -- Because a sum of all nodes needs to be obtained and inquired, a
“SHARD” sentence is used during the inquiry.
    COUNT(*)
    3
    3
    3
    3 rows selected.
    iSQL> SELECT SUM(c1) FROM SHARD(SELECT COUNT(*) c1 FROM t1);
    -- Because a sum of all nodes needs to be obtained and inquired, a
“SHARD” sentence is used during the inquiry.
    SUM(C1)
    9
    1 row selected.
```

The meta node 320 generates a shard connection with respect to all of in-memory DBs 330, 332, 334, and 336 registered in the meta node 320, for each session. When a session is terminated, the shard connection is also terminated.

The meta node 320 analyzes a user query requested by the applications 312, 314, and 316. When the user query is a shard query, a result of the analysis is created, and a plan tree is created by performing a high-quality optimization by the result of the analysis. The meta node 320 may distinguish a case where the user query is a shard query from a case where the user query is not a shard query and process the distinguished cases. When the user query is not a shard query, the meta node 320 processes the user query by serving as a coordinator.

When the shard query is performed, the meta node 320 may perform the created plan tree. When the meta node 420 inquires a plan after performing the shard query, the meta node 420 may check a plan of a shard SQL performed by each of the in-memory DBs 320, 332, 334, and 336. The meta node 320 feeds a result of performing the shard query back to the applications 312, 314, and 316.

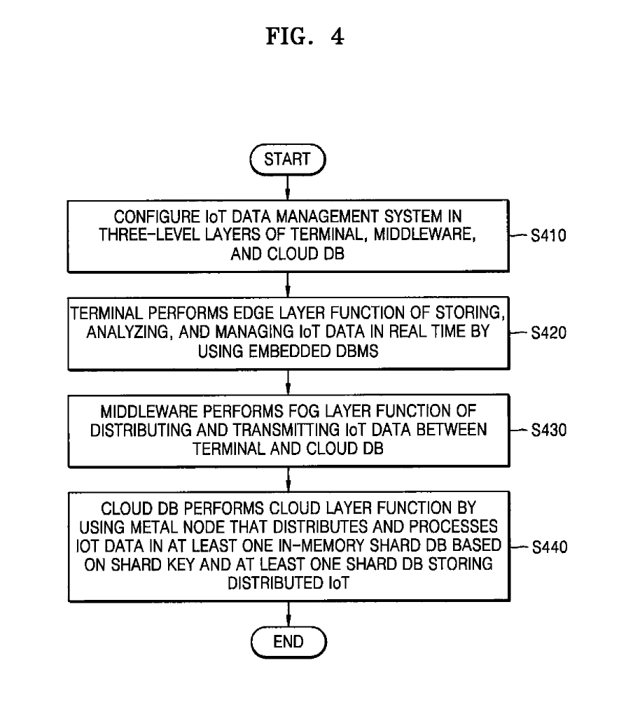

FIG. 4 is a flowchart of a method of configuring an architecture of an IoT data management system in three-level layers, according to an embodiment.

In operation S410, the architecture of the IoT data management system is configured in three-level layers of a terminal, a middleware, and a cloud DB. In operation S420, the terminal includes a terminal configured to generate various IoT data, and performs an edge layer function of collecting, processing, and storing generated IoT data in real time by using embedded DBMS and transmitting the IoT data to the middleware or the cloud DB.

In operation S430, the middleware may distribute and transmit IoT data between the terminal and the cloud DB and may further synchronize IoT data.

According to an embodiment, since the IoT data management system includes hardware including a processor and a storage capable of storing and analyzing IoT data, the IoT data management system may implement the functions of the terminal and the middleware. Examples of the hardware may include Raspberry Pi.

The cloud DB may perform all functions of a general cloud server and may also perform a cloud layer function by implementing cloud sharding by using an in-memory shard DB. In operation S440, the cloud DB performs a cloud layer function by using a meta node that distributes and processes IoT data in at least one in-memory shard DB based on a shard key and at least one shard DB storing distributed IoT data.

One or more embodiments provide an IoT data management system configured in three-level layers. The IoT data management system focuses on the edge layer function at the center of the terminal, thereby satisfying requirements of database for IoT (DoT), such as high scalability, real-time data handling and processing, heterogeneous data processing, transaction integrity, reliability, high availability, and spatiotemporal scalability.

The method can be embodied as computer readable codes on a computer readable recording medium. The computer readable recording medium is any type of recording device that stores data which can thereafter be read by a computer system. Examples of the computer-readable recording medium include ROM, RAM, CD-ROMs, magnetic tapes, floppy discs, and optical data storage media. The computer readable recording medium can also be distributed over network coupled computer systems so that the computer readable code is stored and executed in a distributive manner.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the disclosure as defined by the following claims.

What is claimed is:

1. An Internet of Things (IoT) data management system, wherein the IoT data management system is configured in three-level layers of a terminal, a middleware, and a cloud database (DB),
the terminal implements an edge layer function of storing, analyzing, and managing IoT data in real time,
the middleware implements a fog layer function of distributing and transmitting the IoT data between the terminal and the cloud DB, and
the cloud DB implements a cloud layer function.

2. The IoT data management system of claim 1, wherein the terminal comprises a processor and a storage, and the processor and the storage collect, analyze, and store IoT data in real time.

3. The IoT data management system of claim 2, wherein the terminal supports communication through a gateway function and further supports a function of distributing and controlling the IoT data.

4. The IoT data management system of claim 1, wherein the cloud DB is implemented with a distributed in-memory cloud embedded database management system (DBMS).

5. The IoT data management system of claim 1, wherein the cloud DB comprises:
at least one in-memory shard DB configured to store distributed IoT data; and
a meta node configured to analyze a user query received from the terminal, determine whether the user query is a shard query including a shard object, and when the user query is the shard query, distribute and process IoT data to the at least one in-memory shard DB based on a shard key.

6. The IoT data management system of claim 5, wherein the terminal comprises a shard library provided in a library form in the terminal and configured to perform a coordinator role between the terminal and the at least one in-memory shard DB, transmit the user query to the meta node, receive information about the at least one in-memory shard DB, and perform a connection between the terminal and the at least one in-memory shard DB.

7. A method of generating an architecture of an Internet of Things (IoT) data management system, the method comprising:
generating three-level layers of a terminal, a middleware, and a cloud database (DB);
performing, by the terminal including a processor and a storage, an edge layer function of storing, analyzing, and managing IoT data in real time;
performing, by the middleware, a fog layer function of distributing and transmitting the IoT data between the terminal and the cloud DB; and
performing, by the cloud DB, a cloud layer function.

8. The method of claim 7, wherein the cloud DB is implemented with a distributed in-memory cloud embedded database management system (DBMS).

9. The method of claim 7, wherein the cloud DB comprises:
at least one in-memory shard DB configured to store distributed IoT data; and
a meta node configured to analyze a user query received from the terminal, determine whether the user query is a shard query including a shard object, and when the user query is the shard query, distribute and process IoT data to the at least one in-memory shard DB based on a shard key.

10. The method of claim 9, wherein the terminal comprises a shard library provided in a library form in the terminal and configured to perform a coordinator role between the terminal and the at least one in-memory shard DB, transmit the user query to the meta node, receive information about the at least one in-memory shard DB, and perform a connection between the terminal and the at least one in-memory shard DB.

11. The method of claim 7, wherein the terminal uses an embedded DB.
